(19) United States
(12) Patent Application Publication
(10) Pub. No.: US 2025/0275561 A1
(43) Pub. Date: Sep. 4, 2025

(54) SLOW-DISSOLVING PRESSED FOOD PRODUCT

(71) Applicant: INSTABOMB LLC, Sherman Oaks, CA (US)

(72) Inventor: Casey DALTON-SCHUTT, Sherwood Forest, CA (US)

(21) Appl. No.: 19/069,974

(22) Filed: Mar. 4, 2025

Related U.S. Application Data
(63) Continuation-in-part of application No. 18/595,174, filed on Mar. 4, 2024, now abandoned.

(51) Int. Cl. A23L 27/00; A23P 30/10

(52) U.S. Cl. CPC A23L 27/70; A23P 30/10

(57) ABSTRACT

A streamlined and scalable process combines all spices and ingredients necessary to be placed into an electric pressure cooker at one time, without those ingredients and spices clogging the portion of the cooker that releases steam. The process includes the perfectly formulated exact recipe. Such a process includes the formation of a food bomb product that is pressed together with the spices, herbs and other ingredients for preparation of a predetermined meal. Such a product can withstand the long cooking time necessary without breaking down spices due to spice breakdown or burning. The food bomb product can sit directly on top of the user-provided meat so that it does not get burned by the bottom of the cooker and is able to dissolve slowly during the cooking process. The ingredients used in the food bomb do not clog the cooker or make it sputter or foam.

### CROSS-REFERENCE TO RELATED APPLICATIONS

This application is a continuation-in-part of U.S. patent application Ser. No. 18/595,174, filed Mar. 4, 2024, the contents of which are herein incorporated by reference.

### BACKGROUND OF THE INVENTION

### 1. Field of the Invention

Embodiments of the invention relate generally to food products and methods for preparing the same. More particularly, embodiments of the invention relate to a pressed food product, and methods for preparing the same, containing spices, herbs and related ingredients for making a meal in a variety of cooking apparatuses, including electric pressure cookers or multicookers.

### 2. Description of Prior Art and Related Information

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

In cooking slow cooked meals in an electric pressure cooker, spices often sink to the bottom thus getting cooked off, resulting in lower flavor.

In the event of using a binding agent with spices to retain their flavor, clogging, foaming, or sputtering of the steam release valve can occur, affecting the quality of the meal as the cooker did not perform at an optimum level and the pressure cooker may be unable to safely release the air pressure automatically. The machine needs to be depressurized and opened up, potentially stirred or shut off. Stopping the cooking process defeats the ‘set it and forget it’ advantages of such a device.

A bouillon cube is another example of a pressed product that may be used in food. Bouillon cubes, however, often contain a starch ingredient, which may be incompatible with some electric pressure cookers. Further, a bouillon cube has a composition that is primarily fat and salt.

In view of the foregoing, there is a need for a food product and a method for making the same, the provides a slow cooked meal without the fear of foaming, clogging the machine or preventing a pressure cooker from being able to release the hot pressurized air. There is a further need to provide such a food product and method for making the same that can provide spices to the cooker to maintain a good flavor profile of the cooked meal.

### SUMMARY OF THE INVENTION

Embodiments of the present invention aim to solve the aforementioned problems in electric pressure cooking by providing a pressed food product that includes spices, herbs and other ingredients (such as fruits, vegetables, nuts, or the like) to provide a simple, convenient and fast method for creating meals in such cooking devices. In some embodiments, the food product can include herbs, spices and other ingredients to be used in an electric pressure cooker, such as an Instant Pot®, to make Birria, a traditional slow cooked Mexican meal, for example. The use of the electric pressure cooker can provide a meal in up to 70 percent less time than traditional slow cooking, however, as discussed below, there are unique considerations that are required for cooking with such devices.

The manufacturing process and specific ingredients are perfectly formulated to be used under high-pressure (such as those pressures found in electric pressure cookers, such as the Instant Pot®) and extremely high heat (such as the temperatures found in electric pressure cookers, such as the Instant Pot®) for an extended period of time. The formulation and recipe do not use any starch or thickening agents, unlike other recipes that could be problematic for an electronic pressure cooker.

Embodiments of the present invention provide a process for making a food bomb, comprising combining a plurality of spices and/or herbs in a uniform mixture, the uniform mixture being free from starches, thickening agents and fats; adding one or more liquid ingredients to achieve a food bomb mixture having a moisture-to-mixture consistency permitting compression forming of the food bomb; placing the food bomb mixture into a mold; applying pressure to the food bomb mixture to create a solid food bomb; and removing the solid food bomb from the mold.

In some embodiments, the created solid food bomb has a density from 250 to 7000 grams per liter.

In some embodiments, the applied pressure is from 80 to 125 psi.

In some embodiments, the plurality of spices includes less than 10 percent by weight of salt.

In some embodiments, the one or more liquid ingredients include at least one of lime juice and vinegar.

In some embodiments, the plurality of spices and/or herbs includes at least 10 distinct herbs and/or spices.

In some embodiments, the process further comprises drying the removed solid food bomb.

In some embodiments, the food bomb is composed and manufactured to disintegrate at a controlled rate inside an operating electric pressure cooker, the controlled rate provides disintegration of the food bomb over a time of at least 5 minutes from a start time of the electric pressure cooker. In some embodiments, the controlled rate is adjusted by varying an amount of pressure applied to the food bomb mixture or the amount of time the pressure is applied.

In some embodiments, the plurality of spices and/or herbs are selected to permit the electric pressure cooker to be closed during an entirety of the meal cooking time.

Embodiments of the present invention provide a process for making a solid compressed mixture of ingredients for a recipe comprising combining a plurality of spices and/or herbs in a uniform mixture, the uniform mixture being free from starches, thickening agents and fats; placing the food bomb mixture into a mold; applying pressure to the food bomb mixture to create a solid food bomb; and removing the solid food bomb from the mold.

Embodiments of the present invention provide a product formed by one of the processes described herein. Such a product is defined by the process steps by which the product is made. The process steps would be expected to impart distinctive structural characteristics to the final product, such as the specific densities of the resulting food bomb, the disintegration rates of the resulting food bombs, the specific exclusion of starches and thickening agents, and the like. As discussed herein, these features provide significant benefits over conventional spices, bullions or the like.

Traditional recipes require whole chili and vegetables with hours of cooking and hours of preparation to achieve the end result of a balanced meal with multiple vegetables, herbs and spices. Further, a user is required to source all of the desired ingredients for a given recipe, which can be difficult to find and costly. In the food bomb, according to aspects of the present invention, all of these natural ingredients can be combined, without the use of MSG or any meat-based bouillon, to achieve a healthy meal. In some embodiments, the resulting meal, prepared by the food bomb, according to aspects of the present invention, can also be used in any vegan dish as it does not contain any meat products.

These and other features, aspects and advantages of the present invention will become better understood with reference to the following drawings, description and claims.

### BRIEF DESCRIPTION OF THE DRAWINGS

Some embodiments of the present invention are illustrated as an example and are not limited by the figures of the accompanying drawings, in which like references may indicate similar elements.

FIG. 1 illustrates a perspective view of an electric pressure cooker usable for cooking a meal with a food bomb according to an exemplary embodiment of the present invention;

FIG. 2 illustrates a food bomb according to an exemplary embodiment of the present invention; and

FIG. 3 illustrates a process for making a food bomb according to an exemplary embodiment of the present invention.

The illustrations in the figures may not necessarily be drawn to scale.

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

### DETAILED DESCRIPTION OF THE PREFERRED EMBODIMENTS AND BEST MODE OF INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

As is well known to those skilled in the art, many careful considerations and compromises typically must be made when designing for the optimal configuration of a commercial implementation of any system, and in particular, the embodiments of the present invention. A commercial implementation in accordance with the spirit and teachings of the present invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

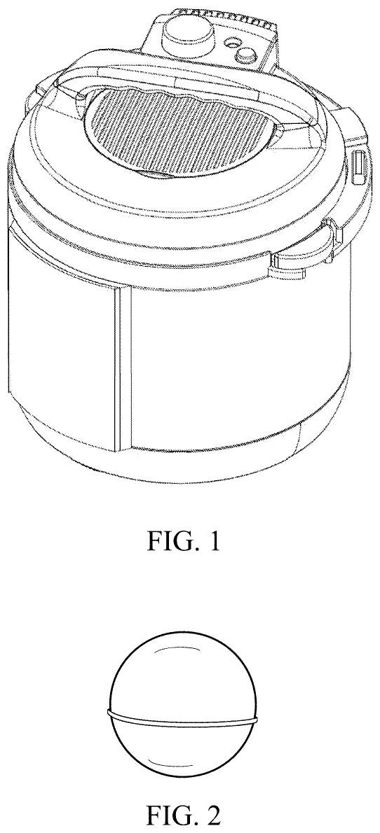

Broadly, embodiments of the present invention provide a streamlined and scalable process of being able to put all spices and ingredients necessary into an electric pressure cooker, such as the one illustrated in FIG. 1, at one time without those ingredients and spices clogging the portion of the cooker that releases steam. Such a process includes the formation of a food bomb product, such as that shown in FIG. 2, that is pressed together with the spices, herbs and other ingredients for preparation of a predetermined meal. Such a product can withstand the long cooking time necessary without breaking down spices due to spice breakdown or burning. The food bomb product can sit directly on top of the user-provided meat so that it does not get burned by the bottom of the cooker and is able to dissolve slowly during the cooking process. The various formulations, including complicated recipes of multiple ingredients (sometimes more than 15 ingredients), are perfectly balanced. There's no MSG, chicken or beef stock or base, and vegan-friendly ingredients are available for those that choose an alternative protein. The ingredients used in the food bomb do not clog the cooker or make it sputter or foam, causing the machine to be turned off, potentially causing the meal to fail or create a huge mess.

Unlike a bath bomb, where a minimum of two separate ingredients is used in order to create an effervescent chemical reaction upon touching water, quickly fizzing, foaming and dissolving into the liquid, typically in less than 30 seconds, the food bomb, according to aspects of the present invention, is not designed or intended to be used in baths or on topical applications. Preferred embodiments of the food bomb omit effervescent ingredients and do not create any effervescent chemical reactions upon touching water. The food bomb provides a combination of spices and ingredients that allow for a specific meal to be produced in an electronic pressure cooker, such as an Instant Pot®, that has the actual opposite intent of the prior art bath bomb, by slowly dissolving and releasing the different spices that will remain in the liquid, and remain in its spice form (i.e., crushed bay leaves). With this functionality, the application of the food bomb is designed to maintain its color and flavor for a minimum of one hour and 45 minutes and up to the maximum of eight hours of cooking time, enough to complete the meal.

In some embodiments, the food bomb can include a mixture of at least 5 different herbs and/or spices. In other embodiments, the food bomb can include a mixture of at least 8 different herbs and/or spices. In still other embodiments, the food bomb can include a mixture of at least 10 different herbs and spices.

Unlike a bouillon cube, which is designed as a quick-dissolve product, the food bomb, according to aspects of the present invention, is a slow-release product. The bouillon cube's primary use is in on a stovetop, with no pressure applied, not in an electric pressure cooker. Further, the bouillon cube contains fat(s) and starch(es), whereas the food bomb, according to aspects of the present invention, is preferably free from most, if not all, fats and starches.

The food bomb, according to aspects of the present invention, does not contain any animal-based products or manufactured products, such as, as non-limiting examples, chicken or beef bouillon or stock, MSG, starches, xanthan gum, or the like. The food bombs, according to aspects of the present invention can further be free of any product that contains MSG. The food bombs, according to aspects of the present invention can also be free of thickeners, including starches, xanthan gum, or the like. In typical embodiments, the food bomb is vegan-friendly.

Accordingly, aspects of the present invention provide a food bomb that is the first all-in-one spice bomb to solve specific problems when cooking in an electric pressure cooker, such as an Instant Pot®, such as clogging the steam release, while preventing sputtering, foaming and frothing, potentially losing the whole meal or getting injured or burned by the steam while trying to clean up or clear the pressure cooker's air release valve. The food bomb also solves the common problem of the overcooking of common ground spices which fall to the bottom of the electric pressure cooker, causing the food to taste bland. The food bomb, according to aspects of the present invention, is designed to include all ingredients needed that can withstand high temperatures and pressure for an extended period of time without breaking down or losing flavor. This balanced measured amount of spices dissolves slowly and solves the common problem of needing to continue to open the pot, that can lose steam and heat while also increasing the chance of being burned. The food bomb, according to aspects of the present invention, can be placed in the pot with all ingredients and not opened again until the meal is ready to be served.

Unlike any other existing method applicable in an electric pressure cooker, the food bomb, according to aspects of the present invention, eliminates the need for ingredients that could potentially pose harm or damage to both individuals and the device itself. By encompassing all the essential traditional herbs, spices and ingredients required for crafting a authentic dish, the food bomb can simplify the cooking process to a single step: adding the food bomb to a pot containing only water and either meat or a protein alternative. This innovative solution is designed to withstand high-pressure and high heat, resulting in an effortlessly-prepared, delectable and flavorful meal.

The process of making the food bomb, as discussed in greater detail below is also revolutionary in creating a balanced meal all-in-one sphere. In the preferred embodiment, for example, the sphere may have a diameter or cross dimension that ranges from 1 to 3 inches, with a more preferred diameter of approximately 2 inches that can dissolve slowly to create a marvelous meal. The production of the food bomb includes a homogenous blend of ingredients that can consistently be reproduced at scale.

As used herein, the term “dissolve” refers to the separation of a single, solid food bomb into its separate ingredients. It should be understood that, as used herein, the term “dissolve” may not require that the ingredients are entirely soluble, but only refers to the separation of the food bomb. In some embodiments, the term “disintegrates” may be used interchangeably with the term “dissolves”.

As discussed in greater detail below, a “slow” dissolve can refer to dissolving as a percentage of the overall cooking time. In the preferred embodiment, such a slow dissolving time may comprise the first 10%, 20%, the first 30%, the first 40%, the first 50%, the first 60%, the first 70%, the first 80% or the first 90% of the overall cooking time. Additionally, such a preferred slow dissolving time may comprise a flat rate dissolving time that may include at least 5 minutes, at least 10 minutes, at least 20 minutes, at least 30 minutes, at least 40 minutes, at least 50 minutes or at least 60 minutes for the food bomb to dissolve.

### General Process Standards

The examples below provide preferred standards for the manufacture of food bombs according to embodiments of the present invention. The manufacturing of the food bombs, according to aspects of the present invention, can be performed in a climate controlled area, within an ambient temperature range of 50-80° F. with a relative humidity of 10-60%. The manufacturing can further be performed under FDA good manufacturing practices (GMP) and can be compliant with all local, state and federal food safety laws. For quality control and tracking purposes, prior to the beginning of the manufacturing process of any food bomb formulation, a batch/lot number can be assigned to all products manufactured from the base ingredients allocated to that specific batch/lot.

### EXAMPLES

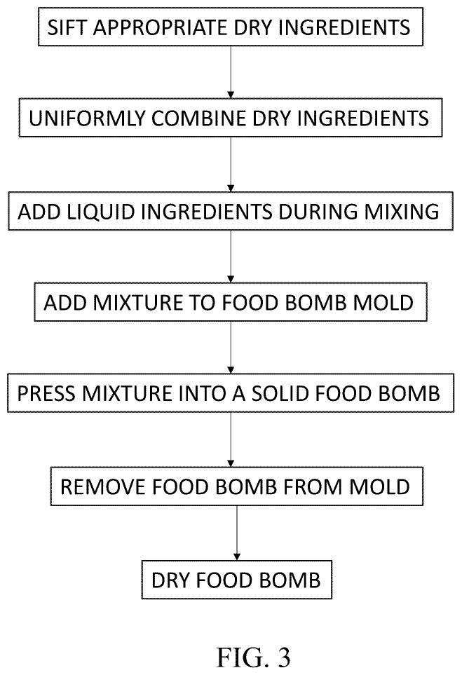

Below is a preferred manufacturing process for an embodiment of a food bomb designed for the preparation of birria. The same or similar process steps are used in manufacturing other traditional slow-cooked authentic dishes, like Birria, curry, or Mole, as well, though the sifting may differ between formulations as the combinations and percentages of the ingredients are subject to change. The process is illustrated in the flow chart of FIG. 3, as an exemplary embodiment.

In the preferred embodiment, the food bomb for birria can include 15 ingredients, 13 dry ingredients and 2 liquid ingredients. The dry ingredients can include guajillo chili powder, salt, ancho chili powder, oregano, onion powder, ground bay leaves, ground cinnamon, ground cloves, allspice, tomato powder, granulated garlic, arbol chili powder and cumin. The liquid ingredients can include vinegar and lime juice. As can be seen in the table below, the food bomb for birria includes about 5% salt. Typically, the food bombs of the present invention include less than 10% by weight salt.

Each individual ingredient for the batch is measured to the recipe specification at the desired quantity that is to be manufactured. In a preferred embodiment, exemplary percentages of each ingredient in a food bomb for birria may comprise:

| | % of weight at time of manufacture |
|---|---|
| DRY INGREDIENT | |
| GUAJILLO CHILI POWDER | 8.33% |
| SALT | 5.0% |
| ANCHO CHILI POWDER | 6.67% |
| MEXICAN OREGANO | 1.67% |
| GROUND BAY LEAVES | 6.67% |
| ONION POWDER | 13.33% |
| GROUND CINNAMON | 5.0% |
| GROUND CLOVES | 3.33% |
| ALLSPICE | 11.67% |
| GARLIC POWDER | 11.67% |
| TOMATO POWDER | 1.67% |
| ARBOL CHILI POWDER | 6.67% |
| CUMIN | 1.67% |
| BLACK PEPPER | 1.67% |
| LIQUID INGREDIENT | |
| VINEGAR | 5.0% |
| LIME JUICE | 5.0% |

Prior to mixing, the Guajillo chili powder, the Ancho chili powder, the onion powder, the ground bay leaves, the ground cinnamon, the ground cloves, the allspice, the Arbol chili powder, the cumin and the tomato powder are each sifted to prevent clumping for a uniform consistency. The dry ingredients are then placed into a rotating food-safe container and mixed to homogeneity. During the mixing, vinegar and lime juice are incrementally added into the food-safe container with the dry ingredient mixture, to achieve desired moisture-to-mixture consistency for the compression forming of the food bomb.

In another embodiment, exemplary percentages of each ingredient in a food bomb for mole may comprise:

| | % of weight at time of manufacture |
|---|---|
| DRY INGREDIENT | |
| COCOA POWDER | 4.55% |
| GUAJILLO CHILI POWDER | 9.09% |
| ANCHO CHILI POWDER | 2.27% |
| MEXICAN OREGANO | 9.09% |
| CUMIN | 2.27% |
| ONION POWDER | 2.27% |
| GARLIC POWDER | 2.27% |
| CORIANDER | 2.27% |
| PAPRIKA | 9.09% |
| BLACK PEPPER | 2.27% |
| SESAME SEEDS | 6.82% |
| SALT | 2.27% |
| GINGER | 4.55% |
| RAISINS | 4.55% |
| SLICED ALMONDS | 2.27% |
| BAY LEAVES | 9.09% |
| CINNAMON | 2.27% |
| SUGAR | 2.27% |
| LIQUID INGREDIENT | |
| VINEGAR | 6.82% |
| LIME JUICE | 6.82% |

In another embodiment, exemplary percentages of each ingredient in a food bomb for Indian curry may comprise:

| | % of weight at time of manufacture |
|---|---|
| DRY INGREDIENT | |
| ONION POWDER | 12.50% |
| GARLIC POWDER | 5.0% |
| CURRY POWDER | 7.5% |
| CUMIN | 7.5% |
| TURMERIC | 7.5% |
| GINGER | 5.0% |
| BLACK PEPPER | 2.5% |
| SALT | 7.5% |
| CORIANDER | 7.5% |
| CHILI POWDER | 2.5% |
| SUGAR | 2.5% |
| CINNAMON | 7.5% |
| BAY LEAVES | 2.5% |
| LIQUID INGREDIENT | |
| LIME JUICE | 5.0% |

The preparation of the Birria food bomb is continued below.

A 2″×13 bath bomb lower mold (“lower mold”) is prepared to receive the food bomb mixture by placing it into a food-safe tub. The homogenized food bomb mixture is then poured from the mixing container into the lower mold. Any excess mixture is gently removed from the top of the lower mold with a food-safe hard plastic scraper, and the excess mixture then falls into the food-safe tub.

The lower mold is then inserted into the pneumatic-powered multi-press bath bomb machine (“machine”) and aligned with the 2″×13 bath bomb upper mold. Once alignment is complete, the machine's press function is activated to press the food bomb mixture into 13 food bombs. The food bombs can be pressed under sufficient pressure and for sufficient time to form a solid food bomb product that does not inadvertently break apart. For example, the food bombs can be made under pressure and time constraints similar to the processes for making bath bombs.

Upon completion of the machine's operating cycle, the lower mold, containing the 13 food bombs, is removed from the machine. The lower mold is then pressed against 13 aligned dowels to remove the food bombs from the lower mold. Each food bomb is then placed onto a food-safe tray for drying. The resulting food bomb can be considered a single, solid product that can be used as described herein.

The prepared food bombs can then be stored in an appropriate manner for future use. In some embodiments, the food bombs can be packaged into a jar containing one or more food bombs, such as two food bombs. A user can remove one food bomb for use, and replace the lid until the remaining food bomb(s) are used.

To use the food bomb, a user can simply open the electric pressure cooker, place a quantity of water (four cups for example) and 1 to 3 pounds of protein or protein substitute (such as chuck roast, for example) into the electric pressure. One of the food bombs can be placed on top of the protein, close the top, and the timer can be set for an appropriate cooking time, such as one hour and 45 minutes. When the timer goes off the steam can be released and the top opened to provide the meal, such as a birria meal based on the above example.

While a 13 bomb making machine is described above, it should be understood that the size and number of food bombs being prepared at a time may vary depending on the machinery used.

The food bomb, while recommended to be used in an electric pressure cooker, such as an Instant Pot®, placed on top of the meat and/or vegetables, can also be used in a multicooker device, a slow cooker (such as a Crock Pot®), or in pot on a stovetop.

While the above describes a bath bomb machine for pressing the food bombs into a generally round shape, the product can take another shape using a different mold that is compatible with the manufacturing equipment. Preferably, the alternative mold volume would have a similar volume as the original food bomb shape, and the product weight is preferably in the range of 1 ounce (oz) to 5 oz, and more preferably at 2.61 oz (74 g). For example, the food bomb can be prepared with a flattened side to prevent the food bomb from moving off the meat or vegetables during the slow dissolving thereof during the cooking process.

While the above example provides one food (birria) that can be prepared with the food bombs of the present invention, the food bombs can be prepared to provide spices, herbs and other ingredients for other recipes. The unique formulations intentionally does not include any processed foods that include MSG, chicken or beef bouillon or stock. The food bomb can be vegan-friendly and can use all one-source ingredients that are natural.

It is noted that the above description describes the food bomb as being slow dissolving. Such a slow dissolving may take from about 10 to about 99 percent of the overall cooking time, typically over 50 percent of the overall time, and sometimes even over 70 percent of the cooking time. The slow dissolving can provide a slow release of the spices, herbs and other ingredients that make up the food bomb, thus preventing overcooking or burning of these components. The dissolving rate may be controlled, for example, by the amount of pressure and time used in pressing the food bomb into its solid form, where increased pressure and/or time may slow the dissolving rate. Thus, as a food bomb is made for recipes using different cooking times, the pressure and press time can be adjusted so that the food bomb slowly dissolves, relative to the overall cooking time (such as fully dissolves at 70 percent of the total cooking time, for example). Thus, by controlling the slow dissolving rate of the food bomb, the release of the herbs and spices can be controlled to prevent overcooking and/or burning of these or other ingredients.

In some embodiments, the food bomb can be formed under a predetermined pressure for a predetermined amount of time to provide a desired density of the food bomb. For example, a density of the food bomb may range from about 250 grams/liter to about 7000 grams/liter. In some embodiments, the density may be from about 500 grams/liter to about 3000 grams/liter. In some embodiments, the density may be from about 600 grams/liter to about 2000 grams/liter. To provide such densities, the pressure applied may be from about 80 psi to about 125 psi. The time the pressure is applied may be from about 5 seconds to about 20 seconds.

In some embodiments, the food bomb can weigh from about 50 grams to 80 grams. In some embodiments, the food bomb can weigh from about 60 grand to 70 grams.

Typically, the food bomb will include all of the spices, herbs and other ingredients needed for a desired recipe. The user need only to add water and, optionally, a protein or protein substitute to the electric pressure cooker. Further, the food bomb provides the ingredients, in a controlled released manner (such as in the slow dissolving manner discussed above) so that there is no need to open the electric pressure cooking at any time during the cooking process. The slow-dissolving food bomb serves multiple purposes while slowly dissolving on the top of the protein or meat alternative. As the pressure builds, and the temperature rises, the water in the device starts moving or boiling to keep all of the ingredients, including the herbs and spices that disintegrate from the body of the food bomb, in motion and moving in the water. This prevents the ingredients from sitting on the bottom of the pot with the potential of being burned through the cooking process.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Claim elements and steps herein may have been numbered and/or lettered solely as an aid in readability and understanding. Any such numbering and lettering in itself is not intended to and should not be taken to indicate the ordering of elements and/or steps in the claims.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what incorporates the essential idea of the invention.

What is claimed is:

1. A process for making a food bomb, comprising:
combining a plurality of spices and/or herbs in a uniform mixture, the uniform mixture being free from starches, thickening agents and fats;
adding one or more liquid ingredients to achieve a food bomb mixture having a moisture-to-mixture consistency permitting compression forming of the food bomb;
placing the food bomb mixture into a mold;
applying pressure to the food bomb mixture to create a solid food bomb; and
removing the solid food bomb from the mold.

2. The process of claim 1, wherein the created solid food bomb has a density from 250 to 7000 grams per liter.

3. The process of claim 1, wherein the applied pressure is from 80 to 125 psi.

4. The process of claim 1, wherein the plurality of spices includes less than 10 percent by weight of salt.

5. The process of claim 1, wherein the one or more liquid ingredients include at least one of lime juice and vinegar.

6. The process of claim 1, wherein the plurality of spices and/or herbs includes at least 10 distinct herbs and/or spices.

7. The process of claim 1, further comprising drying the removed solid food bomb.

8. The process of claim 1, wherein the food bomb is composed and manufactured to disintegrate at a controlled rate inside an operating electric pressure cooker, the controlled rate provides disintegration of the food bomb over a time of at least 5 minutes from a start time of the electric pressure cooker.

9. The food bomb of claim 8, wherein the controlled rate is adjusted by varying an amount of pressure applied to the food bomb mixture or the amount of time the pressure is applied.

10. The food bomb of claim 1, wherein the plurality of spices and/or herbs are selected to permit the electric pressure cooker to be closed during an entirety of the meal cooking time.

11. A process for making a solid compressed mixture of ingredients for a recipe, the process comprising:
combining a plurality of spices and/or herbs in a uniform mixture, the uniform mixture being free from starches, thickening agents and fats;
placing the food bomb mixture into a mold;
applying pressure to the food bomb mixture to create a solid food bomb; and
removing the solid food bomb from the mold.

12. The process of claim 11, wherein the mixture of ingredients include each recipe spice and/or each recipe herb used in the recipe.

13. The process of claim 11, further comprising adding one or more liquid ingredients to achieve a food bomb mixture having a moisture-to-mixture consistency permitting compression forming of the food bomb, wherein the one or more liquid ingredients include at least one of lime juice and vinegar.

14. The process of claim 13, wherein the plurality of spices includes less than 10 percent by weight of salt.

15. The process of claim 11, wherein the created solid food bomb has a density from 250 to 7000 grams per liter.

16. The process of claim 11, wherein the applied pressure is from 80 to 125.

17. The process of claim 11, further comprising drying the removed solid food bomb.

18. The process of claim 11, wherein the food bomb is composed and manufactured to disintegrate at a controlled rate inside an operating electric pressure cooker, the controlled rate provides disintegration of the food bomb over a time of at least 5 minutes from a start time of the electric pressure cooker.

19. A food bomb formed by the process of claim 1.

20. The food bomb of claim 19, wherein the created solid food bomb has a density from 250 to 7000 grams per liter.
